(19) United States
(12) Patent Application Publication
(10) Pub. No.: US 2014/0353404 A1
(43) Pub. Date: Dec. 4, 2014

(54) INDUSTRIAL TRIGGER SPRAYER

(71) Applicant: MeadWestvaco Calmar, Inc., Richmond, VA (US)

(72) Inventor: Donald D. Foster, St. Charles, MO (US)

(21) Appl. No.: 14/374,027

(22) PCT Filed: Jan. 29, 2013
(86) PCT No.: PCT/US13/23550

§ 371 Date: Jul. 23, 2014

Related U.S. Application Data
(60) Provisional application No. 61/592,264, filed on Jan. 30, 2012.

(51) Int. Cl. B05B 11/00; B05B 1/34

(52) U.S. Cl. CPC B05B 11/3011; B05B 1/341
USPC 239/302; 239/574; 239/463

(57) ABSTRACT

According to certain embodiments of the invention, a trigger sprayer may include a plunger and piston combination wherein the piston may include a flap valve or other valve system that opens upon at a certain pressure to allow fluid from within a piston chamber to pass through the plunger and out a nozzle of the trigger sprayer. According to other embodiments of the invention, an inlet valve may be seated between a container and a piston chamber such that fluid may pass the inlet valve upon return of a plunger piston combination to a non-actuated state and such that fluid is prevented from entering the container from the piston chamber when a plunger piston combination is being actuated.

### BACKGROUND OF THE INVENTION

1. Field of the Invention

The present invention relates to trigger sprayers and more particularly to a simplified trigger sprayer design.

2. State of the Art

Trigger sprayers are well known and used around the world. In many instances, a trigger sprayer may be attached to a container or bottle such that the trigger sprayer may dispense fluid or product from the container or bottle. While many different varieties of trigger sprayers are manufactured and used, there is always a need to reduce part count, reduce weight, reduce costs, and improve such trigger sprayers. In addition, in the case of trigger sprayers used in industrial settings—such as for industrial cleaning purposes—improved reliability, cost, and life may be important.

Therefore, it may be desired to produce a trigger sprayer having features which reduce part count, reduce part weight, add resiliency to a trigger sprayer, improve performance, improve functionality, or otherwise improve the use of a trigger sprayer.

### BRIEF SUMMARY OF THE INVENTION

According to certain embodiments of the invention, a trigger sprayer may include a plunger and piston combination wherein the piston may include a flap valve or other valve system that opens upon at a certain pressure to allow fluid from within a piston chamber to pass through the plunger and out a nozzle of the trigger sprayer.

According to other embodiments of the invention, an inlet valve may be seated between a container and a piston chamber such that fluid may pass the inlet valve upon return of a plunger piston combination to a non-actuated state and such that fluid is prevented from entering the container from the piston chamber when a plunger piston combination is being actuated.

In some embodiments of the invention, a trigger sprayer may include a shroud and the shroud may be made of a single material or multiple materials such as by bi-injection of the shroud materials in a mold. In other embodiments, the trigger sprayer may not include a shroud.

### BRIEF DESCRIPTION OF THE DRAWINGS

While the specification concludes with claims particularly pointing out and distinctly claiming particular embodiments of the present invention, various embodiments of the invention can be more readily understood and appreciated by one of ordinary skill in the art from the following descriptions of various embodiments of the invention when read in conjunction with the accompanying drawings in which:

FIG. 1 illustrates a side-view of a trigger sprayer according to various embodiments of the invention;

FIG. 2 illustrates a perspective-view of a trigger sprayer according to various embodiments of the invention;

FIG. 3 illustrates a cross-sectional perspective view of a trigger sprayer according to various embodiments of the invention;

FIG. 4 illustrates a side-view of a trigger sprayer according to various embodiments of the invention;

FIG. 5 illustrates a perspective-view of a trigger sprayer according to various embodiments of the invention;

FIG. 6 illustrates a cross-sectional perspective view of a trigger sprayer according to various embodiments of the invention;

FIGS. 7A through 7D illustrate various views of a trigger sprayer shroud according to certain embodiments of the invention;

FIGS. 8A through 8E illustrate various views of a trigger sprayer nozzle according to certain embodiments of the invention; and

FIGS. 9A through 9D illustrate various views of a trigger sprayer closure according to certain embodiments of the invention.

### DETAILED DESCRIPTION OF THE INVENTION

According to various embodiments of the invention, a trigger sprayer 100 may include housing 110, a valve case or tube retainer 120 fitted within a portion of the housing 110 and an inlet valve 115 controlling fluid or product flow between an opening in the tube retainer 120 and an inlet opening in the housing 110. The housing may also include a piston chamber 113 into which a piston 130 may sit or be mounted for movement therein. The piston 130 may be mounted to, or mated with, a plunger 140 and may include a discharge valve 135 integral therewith. The plunger 140 may be configured with, or mated with, a swirl post 150 at a discharge end with a nozzle 155 also affixed to the discharge end of the plunger 140. An actuator 160 and spring 165 combination may act against or on the plunger 140 to produce movement of the plunger 140 and piston 130. Such movement may actuate the trigger sprayer 100.

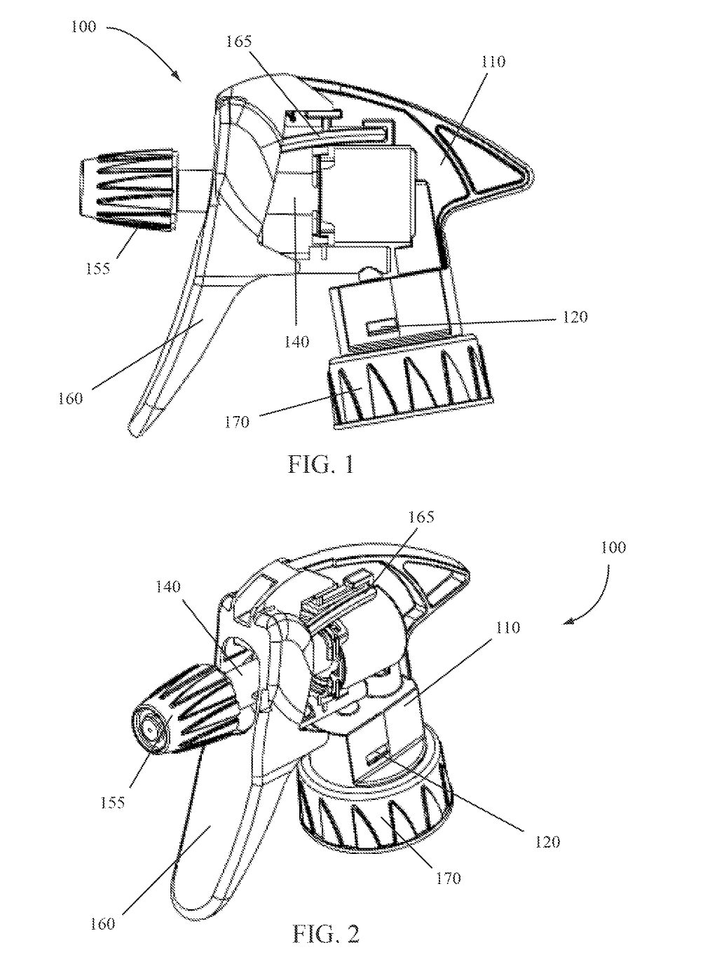

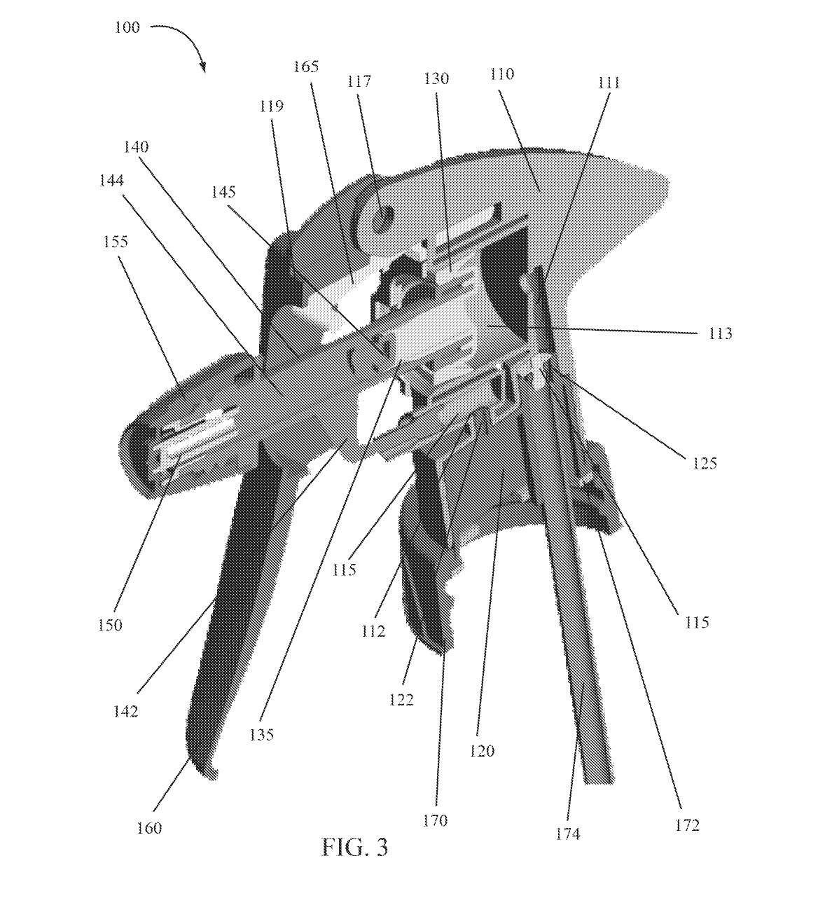

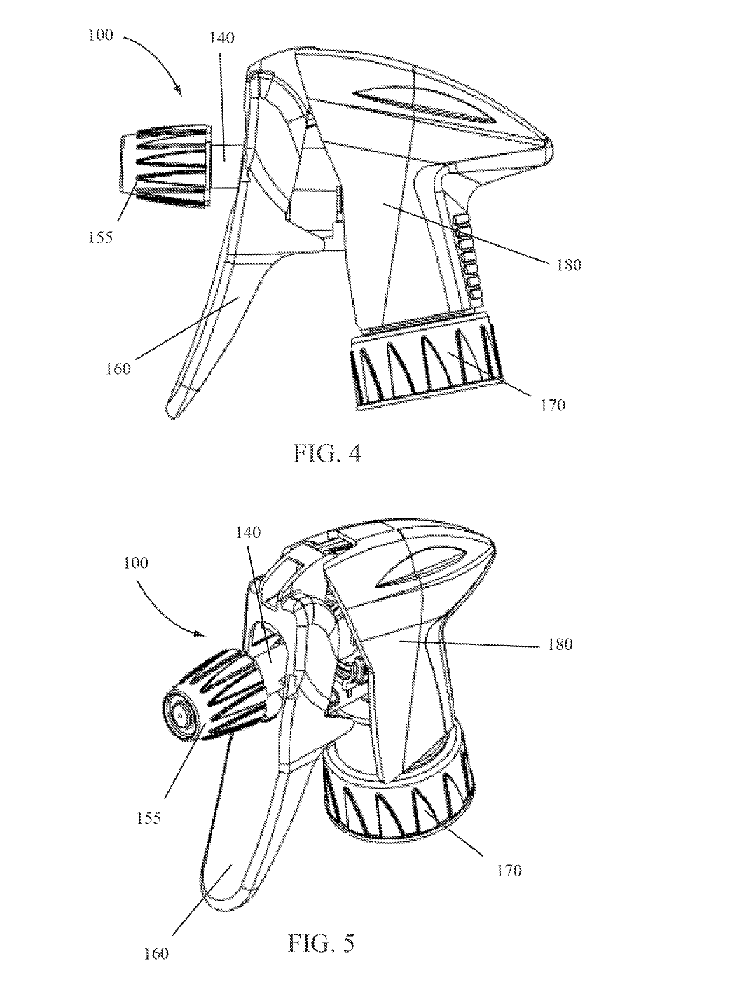

A trigger sprayer 100 according to various embodiments of the invention is illustrated in FIGS. 1 through 3. As illustrated, FIGS. 1 and 2 include exterior views of a trigger sprayer 100 according to various embodiments of the invention. FIG. 3 illustrates a cross-sectional view of the trigger sprayer 100 illustrated in FIGS. 1 and 2.

As illustrated in FIG. 3, a housing 110 according to various embodiments of the invention may include an inlet flow path 111 and a piston chamber 113. A housing 110 may also include a housing vent chamber 115, one or more actuator connection points 117 and one or more spring connection points 119. A housing 110 may be formed of a single, molded piece of plastic or resin material in some embodiments of the invention.

According to various embodiments of the invention, a housing 110 may include a housing vent hole 112 or opening which may be configured to allow a container or bottle to which the trigger sprayer 100 is attached to vent during actuation of the trigger sprayer 100. A housing vent hole 112 may be located in a housing vent chamber 115. In some embodiments of the invention, the tube retainer 120 may include a corresponding valve case vent hole 122 which may mate with, or otherwise communicate with, the housing vent hole 112 to allow a container or bottle to which the trigger sprayer 100 is attached to vent. For example, a housing vent hole 112 and valve case vent hole 122 according to some embodiments of the invention may be configured as illustrated in FIG. 3 or 5. In the illustrated configurations, the housing 110 may also include a housing vent chamber 115 into which a plunger vent arm 142 extends to open and close the vent passageway formed by the housing vent hole 112 and valve case vent hole 122 during actuation of the trigger sprayer 100. While particular configurations are illustrated, it is understood that other venting configurations may be used with various embodiments of the invention.

A tube retainer 120 may mate with the housing 110 or may fit into the housing 110 as illustrated in FIG. 3. In some embodiments of the invention, a tube retainer 120 may snap fit into a housing 110 as illustrated in FIGS. 1 and 2 where a portion of the tube retainer 120 may be seen in a snap fitment of the housing 110. When mated with the housing 110, the tube retainer 120 may include a vent hole 122 corresponding to a housing vent hole 112. In addition, a tube retainer 120 may include a tube retaining portion 124. The tube retaining portion 124 may be configured to mate with or otherwise hold a dip tube 174 in a manner similar, or the same, as the way dip tube retainers for conventional trigger sprayers hold dip tubes. The tube retainer 120 may also include a valve seat 125 upon which the inlet valve 115 may sit or rest as illustrated in FIG. 3. The inlet valve 115 and the valve seat 125 may be shaped or otherwise configured such that the inlet valve 115 may be assembled and removeably fixed to the tube retainer 120 at the valve seat 125 or the inlet valve 115 may be seated against the valve seat 125 by nature of the assembly of the tube retainer 120 with the housing 110.

According to various embodiments of the invention, an inlet valve 115 may include a disc-shaped valve as illustrated in FIG. 3. According to other embodiments of the invention, an inlet valve 115 may include any conventional valve, including a flap valve, ball valve, disk valve or other valve system. In some embodiments of the invention, the inlet valve 115 may be made of a flexible material.

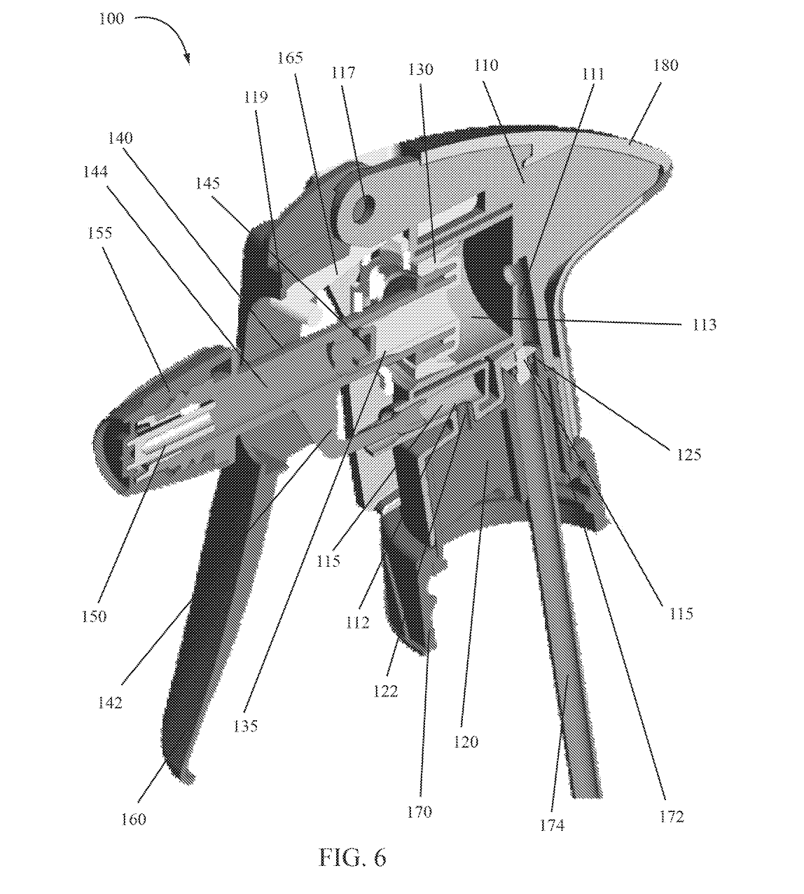

A piston 130 according to various embodiments of the invention may be made of any desirable material. According to some embodiments of the invention, a piston 130 may include an integral discharge valve 135 as illustrated in FIGS. 3 and 6. According to various embodiments of the invention, the discharge valve 135 may include a sleeve-type valve resting against a plunger valve seat 145. According to some embodiments of the invention, as the piston 130 moves within the piston chamber 113 fluid may pass through an opening in the center of the piston 130 and past the discharge valve 135.

According to various embodiments of the invention, a piston 130 may include one or more openings therethrough. The one or more openings may be integrally formed with a discharge valve 135 such that the piston 130 may act as both a piston 130 and discharge valve 135 when operating with a trigger sprayer 100. The use of a piston 130 and discharge valve 135 combination may reduce the part count for a trigger sprayer 100.

A plunger 140 according to various embodiments of the invention may include a hollow portion therethrough acting as a discharge path 144. An inlet end of the plunger 140 discharge path 144 may be positioned near the piston chamber 113 and may mate with the piston 130 such that the piston 130 is mated with or attached to the plunger 140. For example, as illustrated in FIGS. 3 and 6, a piston 130 may include one or more projections which mate with openings in a plunger 140 to fit the piston 130 to the plunger 140 and position the piston 130 within the piston chamber 113. An outlet end of the plunder 140 discharge path 144 may be located at or near a nozzle 155 connection. The plunger 140 may include features to mate with or secure a nozzle 155 to the discharge end of the plunger 140.

According to some embodiments of the invention, the discharge end of the plunger 140 may also include a configuration to fit a swirl post 150 or other device for creating swirl mechanics for the trigger sprayer 100. In some embodiments, a swirl post 150 may fit within an opening in the plunger 140. In other embodiments, a swirl post 150 may attach to the plunger 140 in another manner or may be held against the plunger 140 by attachment of a nozzle 155 or other component.

A plunger 140 according to various embodiments of the invention may also include one or more plunger valve seat 145 within the discharge path 144. According to various embodiments of the invention, the one or more plunger valve seats 145 may interact with a discharge valve 135 such that fluid or product may only pass through the discharge valve 135 upon reaching a certain pressure within the piston chamber 113.

According to various embodiments of the invention, an actuator 160 may be attached to or moveably fitted to the housing 110. A spring 165, such as a metal or plastic spring, may also be fitted to the trigger sprayer 100 and configured to act against the actuator 160 and the housing 110 to facilitate return movement of the actuator 160 following actuation of the trigger sprayer 100. Other configurations of actuators 160 and springs 165 may be used with various embodiments of the invention.

According to various embodiments of the invention, a trigger sprayer 100 may act to pump a fluid or product from a container or bottle to which the trigger sprayer 100 is attached. For instance, upon actuation of an actuator 160 of a trigger sprayer 100, the actuator 160 acts on a plunger 140, which in turn moves the piston 130 within the piston chamber 113 of the housing 110. Movement of the piston 130 within the piston chamber 113 may compress air therein allowing the air to escape past the discharge valve 135. Upon release of the actuation of the actuator 160, the spring 165 acts on the actuator 160, returning the plunger 140 to the rest position which also moves the piston 130 within the piston chamber 113. The movement of the piston 130 in the piston chamber 113 back to a rest, or non-actuated, position, creates a vacuum in the piston chamber 113 which in turn opens the inlet valve 115 and pulls fluid or product from a container into the inlet flow path 111 and piston chamber 113. Actuation of the actuator 160 when the piston chamber 113 is full of fluid acts in a similar manner except that fluid or product from within the piston chamber 113 is expelled past the discharge valve 135 and along the discharge path in the plunger 140 to the swirl post 150 where it is forced out the nozzle 155.

Operation of trigger sprayer devices is well known, and while operation of a trigger sprayer 100 according to various embodiments of the invention is explained herein, it is understood that the operation may vary with different embodiments of the invention and that the general operation of the trigger sprayer 100 does not limit the inventions herein.

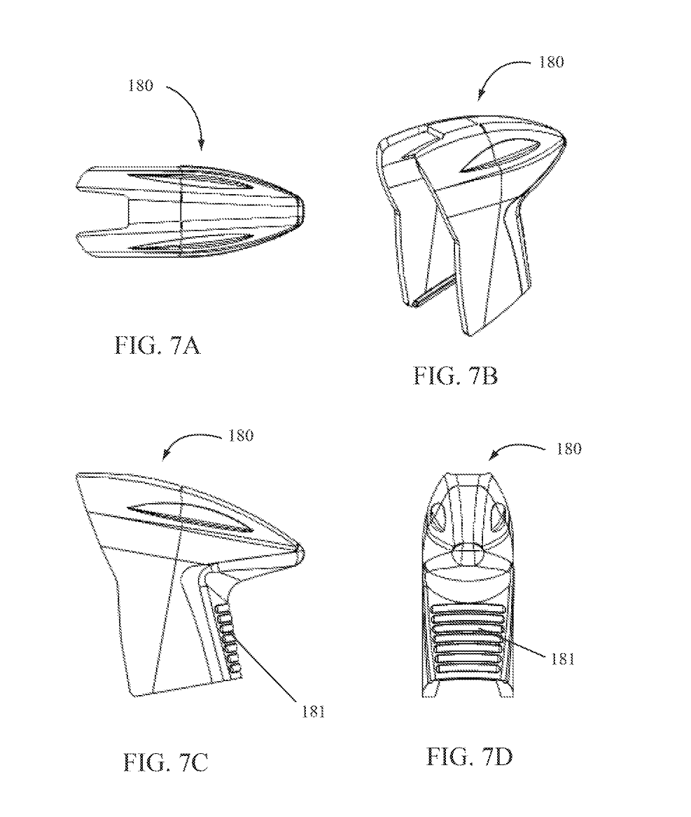

FIGS. 7A through 7D illustrate various top, perspective, side and rear views, respectively, of a shroud 180 according to various embodiments of the invention. According to some embodiments of the invention, a shroud 180 may be molded of a single material or in a single color. According to other embodiments of the invention, a shroud 180 may be molded of multiple materials, multiple colors, or both multiple materials and colors. For example, as illustrated in FIGS. 7C and 7D, a back portion of the shroud 182 may be molded of a different material to improve the feel of the shroud 180 against a user's hand during actuation or carrying of the trigger sprayer 100. In some instances, multiple material usage or multiple color usage may be accomplished using bi-injection techniques and processes.

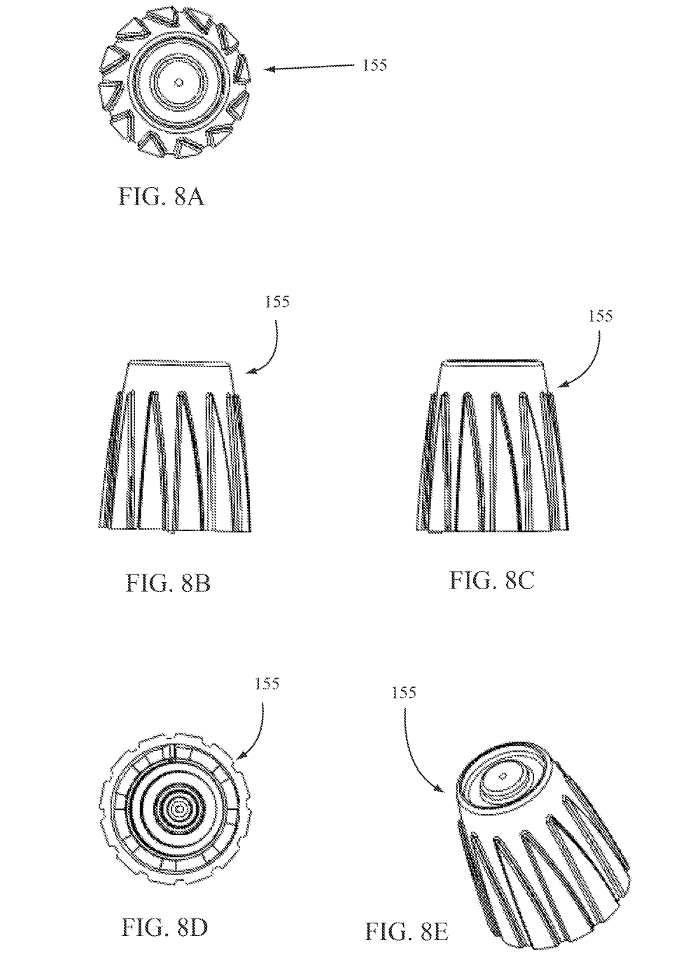

FIGS. 8A through 8E illustrate front, side, side, rear, and perspective views, respectively, of a nozzle 155 according to various embodiments of the invention. A nozzle 155 may include the aesthetic design as illustrated in FIGS. 8A through 8E or may include any other design as desired. A nozzle 155 according to embodiments of the invention may also include other shapes, configurations, and options as are frequently included with conventional trigger sprayers, such as on/off, spray/stream, foam, or other options.

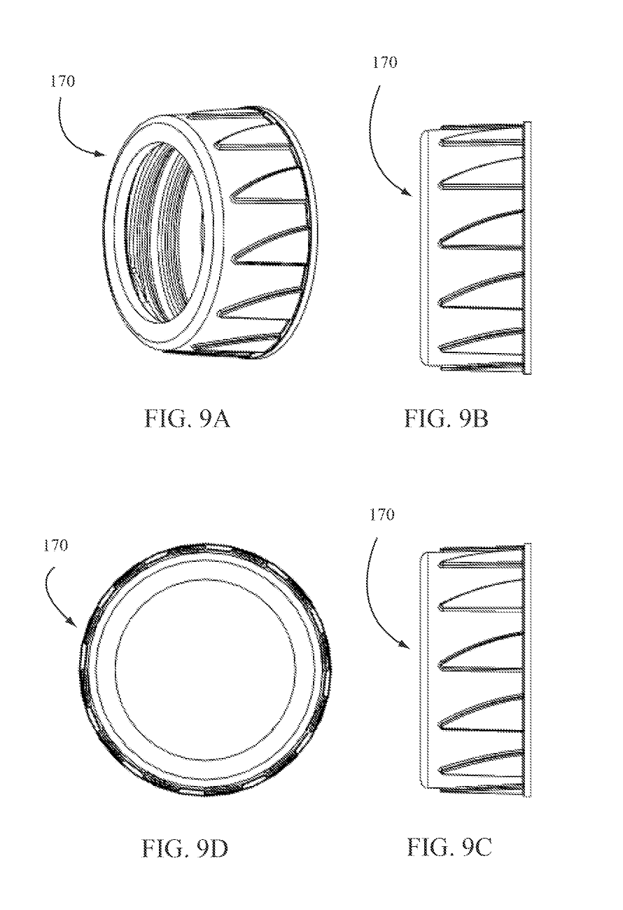

FIGS. 9A through 9D illustrate perspective, side, side, and top views, respectively, of a closure 170 according to various embodiments of the invention. As illustrated, a closure 170 may include an aesthetic design as illustrated. In other embodiments of the invention, a closure 170 may include other designs. A closure 170 may also include different closure mechanisms including twist off mechanisms, bayonet mechanisms, snap fit mechanisms, or other mechanisms as used with conventional trigger sprayers.

Having thus described certain particular embodiments of the invention, it is understood that the invention defined by the appended claims is not to be limited by particular details set forth in the above description, as many apparent variations thereof are contemplated. Rather, the invention is limited only be the appended claims, which include within their scope all equivalent devices or methods which operate according to the principles of the invention as described.

What is claimed is:

1. A trigger sprayer, comprising:
a housing;
a tube retainer seated in a portion of the housing;
an inlet valve between the housing and the tube retainer;
a piston chamber in a portion of the housing;
a plunger comprising a discharge flow path and a plunger valve seat; and
a piston connected to the plunger and seated in the piston chamber, wherein the piston comprises an integral discharge valve seated against the plunger valve seat.

2. The trigger sprayer of claim 1, wherein the inlet valve further comprises a disc-shaped valve.

3. The trigger sprayer of claim 1, wherein the piston further comprises an opening through the piston from a piston end to the integral discharge valve at an opposite end.

4. The trigger sprayer of claim 1, wherein the piston is mated with an end of the plunger.

5. The trigger sprayer of claim 1, wherein the piston comprises at least one projection which mates with the plunger to retain the piston to the plunger.

6. The trigger sprayer of claim 1, further comprising a nozzle secured in a discharge end of the plunger.

7. The trigger sprayer of claim 1, further comprising a swirl post in a discharge end of the plunger.

8. The trigger sprayer of claim 1, further comprising a bottle attached to the housing, wherein the trigger sprayer may be actuated to remove a product from the bottle.

9. The trigger sprayer of claim 1, wherein the housing, tube retainer, inlet valve, piston, and plunger are made of a plastic material.

10. A piston for a trigger sprayer, comprising:
a piston;
a hole through the piston; and
an integral discharge valve formed at one end of the hole.

11. The piston of claim 10, further comprising at least one projection configured to mate with a plunger of a trigger sprayer.

12. The piston of claim 10, wherein the integral discharge valve is configured to seat against a plunger valve seat.
